(19) United States
(12) Patent Application Publication
(10) Pub. No.: US 2005/0237502 A1
(43) Pub. Date: Oct. 27, 2005

(54) Exposure apparatus

(76) Inventor: Haruna Kawashima, Tochigi-ken (JP)

Correspondence Address: MORGAN & FINNEGAN, L.L.P., 3 WORLD FINANCIAL CENTER, NEW YORK, NY, 10281-2101, US

(21) Appl. No.: 11/040,459

(22) Filed: Jan. 21, 2005

(30) Foreign Application Priority Data
Jan. 21, 2004 (JP) 2004-012805 (PAT.

(51) Int. Cl. G03B 27/42

(52) U.S. Cl. 355/53; 355/67

(57) ABSTRACT

An exposure apparatus includes a projection optical system for projecting a pattern of a reticle onto an object, the projection optical system having a numerical aperture of 0.85 or higher, wherein the projection optical system includes an optical element, and an antireflection coating applied to the optical element, the antireflection coating including plural layers, and wherein an incident light angle upon the optical element and an exit light angle from the optical element on a surface of the antireflection coating which contacts gas do not exceed a Brewster angle determined by a relative refractive index between the gas and a final layer among the plural layers, which is the closest to the gas.

### BACKGROUND OF THE INVENTION

The present invention relates generally to an exposure apparatus, and more particularly to an exposure apparatus used to manufacture various devices including semiconductor chips such as ICs and LSIs, display devices such as liquid crystal panels, sensing devices such as magnetic heads, and image pickup devices such as CCDs, as well as fine patterns used for micromechanics.

In manufacturing fine semiconductor devices, such as a semiconductor memory and a logic circuit, using the photolithography, a projection exposure apparatus has been conventionally been used to transfer a circuit pattern on a reticle (or a mask) via a projection optical system onto a wafer etc. The critical dimension transferable in the projection exposure apparatus or resolution is in proportion to a wavelength of the light used for the exposure and in reverse proportion to a numerical aperture (“NA”) of the projection optical system.

Therefore, as the fine processing to the semiconductor devices is demanded, use of the shortened wavelength for the exposure light and a higher NA for the projection optical system are promoted. An early exposure apparatus began with a development of a g-line stepper that uses a g-line ultra-high pressure mercury lamp (having a wavelength of about 436 nm) as a light source and includes a projection optical system with a NA of about 0.3, then an i-line stepper that uses an i-line ultra-high pressure mercury lamp (having a wavelength of about 365 nm) as an light source, and a stepper that uses a KrF excimer laser (having a wavelength of about 248 nm) and includes a projection optical system with a NA of about 0.65. Current widespread projection exposure apparatuses replace these steppers with scanners that use a KrF excimer laser and ArF excimer laser (with a wavelength of approximately 193 nm) as a light source and can include a high-NA projection optical system. The currently commercially available projection optical system with the highest NA has a NA=0.8. The stepper is a step-and-repeat exposure apparatus that moves a wafer stepwise to an exposure area for the next shot for every shot of the cell projection onto the wafer. The scanner is a step-and-scan exposure apparatus that exposes a mask pattern onto a wafer by continuously scanning the wafer relative to the mask, and by moving, after the exposure shot, the wafer stepwise to the next exposure area to be shot.

Scanners that use F₂ laser (with a wavelength of approximately 157 nm) as a light source as well as the KrF and ArF excimer lasers and include a projection optical system with NA=0.85 have been extensively studied. There is a demand for the development of a projection optical system with NA of 0.90.

With such a development of the projection optical system, an antireflection coating has been developed for applications of an optical element in the projection optical system. The applied antireflection coating technology for the visual light used for conventional cameras, etc. can develop an antireflection coating without any significant problem to an exposure apparatus that uses a (g-line or i-line) ultra-high pressure mercury lamp as a light source.

The antireflection coating materials are limited to low index materials having refractive indexes between 1.45 and 1.55, such as SiO₂ and MgF₂, and middle index materials having refractive indexes between about 1.65 and 1.75, such as Al₂O₃ and LaF₃. This limitation increases the design difficulty, lowers the transmission loss due to the light absorptions in the coating, the contaminations of the substrate, and scatters in the coating's layer, which have conventionally been negligible (see, for example, Japanese Patent Application, Publication No. 11-064604).

As disclosed by this inventor in U.S. patent application Ser. No. 10/845,832, the reflectance of the p-polarized light abruptly improves when an angle of the light incident from the air layer upon the antireflection coating's final layer (at the air side) exceeds the Brewster angle determined by the index, as shown in FIG. 8, in a high-NA projection optical system.

In general, the final layer that contact the air uses a low refractive material so as to maintain a low design value of the reflectance in a wide incident-angle range. As shown in FIG. 9, even when the basic coating design changes, the reflectance has a similar value as the incident angle increases as long as the final layer that contact the air is made of the same material.

As to the phase, the transmission phase greatly changes for both the p-polarized light and the s-polarized light when the incident angle exceeds the Brewster angle determined by the index of the final layer of the antireflection coating, negatively influencing the aberration of the projection optical system.

Therefore, the deterioration of characteristics of the projection optical system, such as the transmittance and the imaging performance, becomes problematic due to the limit of the antireflection coating around NA=0.85 (or 58°) which exceeds the Brewster angle determined by the index of the antireflection coating's final layer (at the air side) where the antireflection coating for the F₂ laser, the ArF excimer laser, and KrF excimer layer is made of the limitedly available materials.

### BRIEF SUMMARY OF THE INVENTION

Accordingly, it is an exemplary object of the present invention to provide an exposure apparatus that has a good optical performance.

An exposure method according to one aspect of the present invention includes a projection optical system for projecting a pattern on a reticle onto an object, the projection optical system having a numerical aperture of 0.85 or higher, wherein the projection optical system includes an optical element, and an antireflection coating applied to the optical element, the antireflection coating including plural layers, and wherein an incident light angle upon the optical element and an exit light angle from the optical element, on a surface of the antireflection coating which contacts gas, do not exceed a Brewster angle determined by a relative refractive index between the gas and a final layer among the plural layers, which is the closest to the gas.

An exposure apparatus according to another aspect of the present invention includes a projection optical system for projecting a pattern on a reticle onto an object, and a fluid that fills at least part of a space between the projection optical system and the object, the exposure apparatus exposing the object through the fluid, wherein the projection optical system includes an optical element, and an antireflection coating applied to the optical element, wherein an incident light angle upon the optical element and an exit light angle from the optical element, on a surface of the antireflection coating which contacts the fluid, do not exceed a Brewster angle determined by a relative refractive index between the fluid and a final layer in the antireflection coating, which is the closest to the fluid.

An exposure apparatus according to another aspect of the present invention includes a projection optical system for projecting a pattern on a reticle onto an object, the projection optical system having a numerical aperture of 0.85 or higher, wherein the projection optical system includes an optical element located closest to the object, the optical element having an incident surface upon which light is incident and an exit surfaces from which the light exits, and antireflection coatings applied to the incident and exit surfaces of the optical element, each antireflection coating including plural layers, and wherein the following equations are met where a is an incident angle of the light upon the object, b is an exit angle of the light from the exit surface, and c is an incident angle of the light upon the incident surface c<b≦a Brewster angle determined by a final surface of the antireflection coating on the incident surface, which is the farthest away from the optical element, and c<a Brewster angle determined by a final surface of the antireflection coating on the exit surface, which is the farthest away from the optical element.

An exposure apparatus according to still another aspect of the present invention includes a projection optical system for projecting a pattern on a reticle onto an object, and a fluid that fills at least part of a space between the projection optical system and the object, the exposure apparatus exposing the object through the fluid, wherein the projection optical system includes an optical element located closest to the object, the optical element having an incident surface upon which light is incident and an exit surfaces from which the light exits, and antireflection coatings applied to the incident and exit surfaces of the optical element, and wherein the following equations are met where a is an incident angle of the light upon the object, b is an exit angle of the light from the exit surface, and c is an incident angle of the light upon the incident surface c<b≦a Brewster angle determined by the antireflection coating on the incident surface, and c<a Brewster angle determined by the antireflection coating on the exit surface.

Other objects and further features of the present invention will become readily apparent from the following description of the preferred embodiments with reference to the accompanying drawings.

### BRIEF DESCRIPTION OF THE DRAWINGS

FIG. 1 is a schematic structure of an exposure apparatus according to one aspect of the present invention.

FIG. 2 is a partially enlarged view of a projection optical system shown in FIG. 1 at a side of the object to be exposed.

FIG. 3 is a graph showing a transmittance of a plane-parallel plate relative to a maximum incident angle.

FIG. 4 is a schematic block diagram showing the exposure apparatus that arranges a plane-parallel plate for correcting an aberration of the projection optical system and a plane-parallel plate for preventing a sublimate from contaminating the projection optical system.

FIG. 5 is a wet projection optical system at the side of the object to be exposed.

FIG. 6 is a flowchart for explaining how to fabricate devices (such as semiconductor chips such as ICs and LCDs, CCDs, and the like).

FIG. 7 is a detail flowchart of a wafer process as Step 4 shown in FIG. 6.

FIG. 8 is a graph showing reflectance changes and a Brewster angle relative to incident angles upon an antireflection coating.

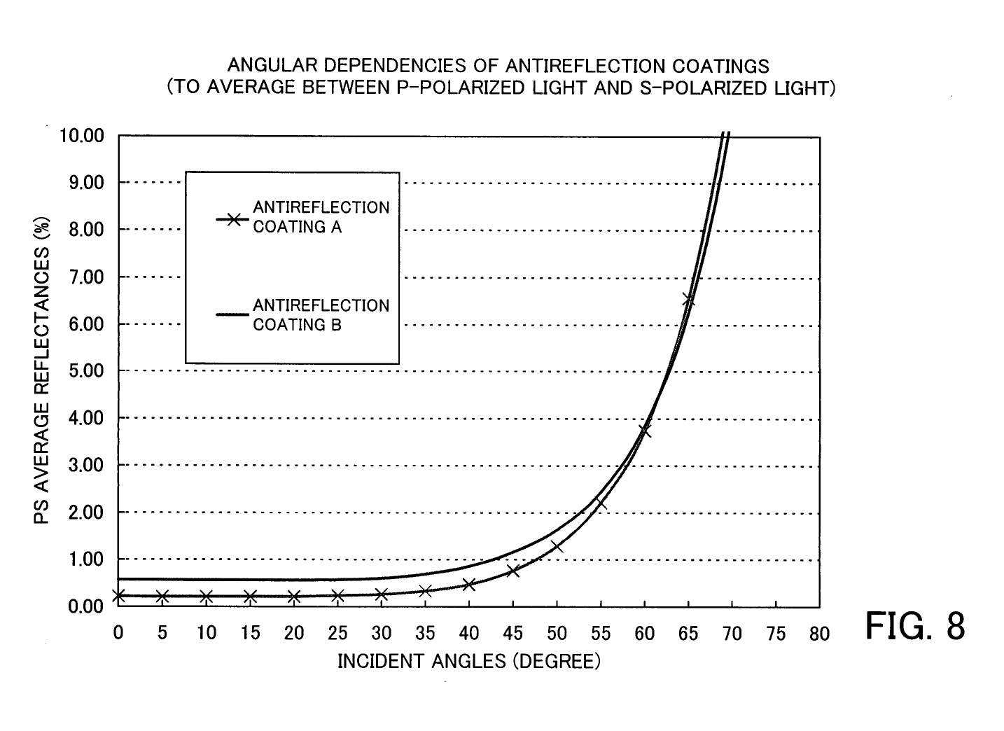

FIG. 9 is a graph showing the reflectance changes relative to the incident angles upon the antireflection coating.

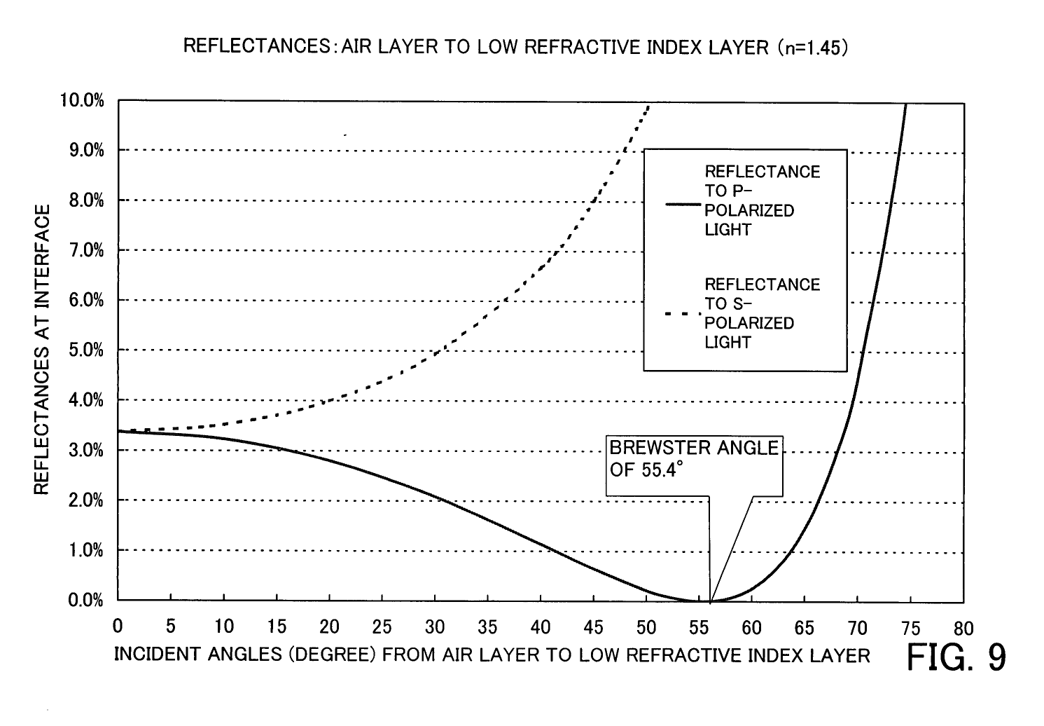

### DETAILED DESCRIPTION OF THE PREFERRED EMBODIMENTS

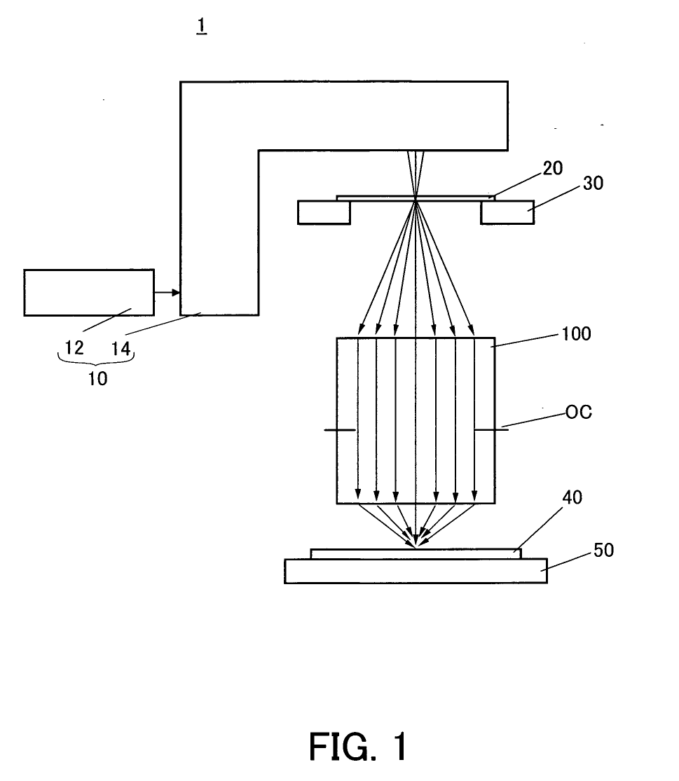

With reference to the accompanying drawings, a description will now be given of preferred embodiments of the present invention. In each figure, the like element is designated by the similar reference numeral, and a duplicate description will be omitted. FIG. 1 is a schematic block diagram showing a structure of the exposure apparatus 1 according to one aspect of the present invention.

The exposure apparatus 1 is a projection exposure apparatus that exposes a circuit pattern of a reticle 20 onto an object 40, for example, in a step-and-repeat or a step-and-scan manner. This exposure apparatus is suitable for a submicron or quarter-micron lithography process, and this embodiment exemplarily describes a step-and-scan exposure apparatus.

The exposure apparatus 1 includes, as shown in FIG. 1, an illumination apparatus 10 that illuminates the reticle 20 that has a circuit pattern, a reticle stage 30 that supports the reticle 20, a projection optical system 100 that projects diffracted light generated from the illuminated reticle 20's circuit pattern onto the object 40, and a wafer stage 50 that supports the object 40.

The illumination apparatus 10 illuminates the reticle 20 that has the circuit pattern to be transferred, and includes a light source unit 12 and an illumination optical system 14.

The light source unit 12 can use as a light source, for example, an ArF excimer laser with a wavelength of approximately 193 nm, and a KrF excimer laser with a wavelength of approximately 248 nm. However, the type of the light source is not limited to the excimer laser, and it can use a F₂ excimer laser with a wavelength of approximately 157 nm. The number of light sources is not limited. An optical system for reducing speckles may swing linearly or rotationally. When the light source unit 12 uses a laser, it is desirable to employ a beam shaping optical system that shapes a parallel beam from a laser source to a desired beam shape, and an incoherently turning optical system that turns a coherent laser beam into an incoherent one. A light source applicable to the light source unit 12 is not limited to a laser, and may use one or more lamps such as a mercury lamp and a xenon lamp.

The illumination optical system 14 is an optical system that illuminates the reticle 20, and includes a lens, a mirror, an optical integrator, a stop, and the like. The illumination optical system 14 arranges, for example, a condenser lens, a fly-eye lens, an aperture stop, a condenser lens, a slit, and an imaging optical system in this order. The illumination optical system 14 can use any light whether it is on-axial or off-axial light. The optical integrator may include a fly-eye lens or an integrator formed by stacking two sets of cylindrical lens array plates (or lenticular lenses), and may be replaced with an optical rod or a diffractive element.

The reticle 20 is made from quartz, for example, has a circuit pattern (or an image) to be transferred, and is supported and driven by a reticle stage 30. Diffracted light emitted from the reticle 20 passes through the projection optical system 100, thus and then is projected onto the object 100. The reticle 20 and the object 40 are located in an optically conjugate relationship. Since the exposure apparatus 1 of this embodiment is a step-and-scan exposure apparatus, the reticle 20 and the object 40 are scanned at a speed ratio of a reduction ratio of the object 40, thus transferring the pattern on the reticle 20 to the object 40. If it is a step-and-repeat exposure apparatus (referred to as a “stepper”), the reticle 20 and the object 40 remain still for exposure.

The reticle stage 30 supports the reticle 20 via a reticle chuck (not shown), and is connected to a transporting mechanism (not shown). The transporting mechanism (not shown) includes a linear motor, etc., and drives the reticle stage 30 in XYZ-axes directions and rotational directions around these axes, and moves the reticle 20. Here, the Y-axis is defined as a scan direction on a surface of the reticle 20 or the object 40, the X-axis is defined as a direction perpendicular to the scan direction, and Z-axis is defined as a direction perpendicular to the surface of the reticle 20 or the object 40.

The projection optical system 100 is an optical system that projects the light that reflects a pattern on the reticle 20 onto the object 40, and has a NA of 0.85. The projection optical system 100 in this embodiment has a aperture stop OC, and projects, onto the object 40, the light only within the predetermined aperture among the diffracted light from the circuit pattern on the reticle 20. The projection optical system 100 includes optical elements, such as a lens, on which an antireflection coating that includes plural layers is formed.

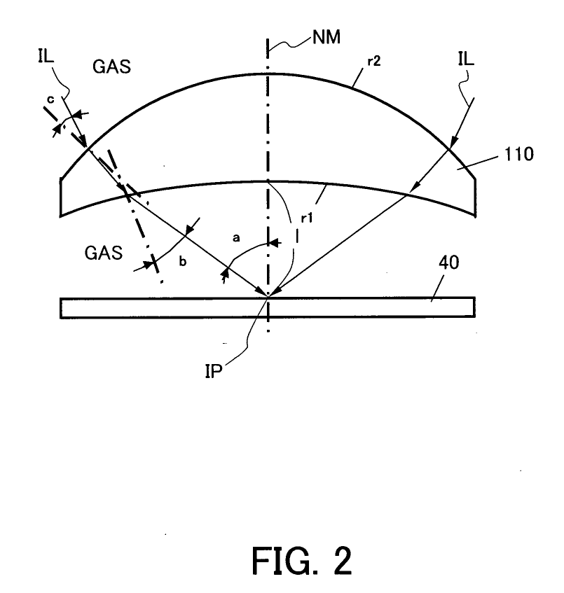

Referring now to FIG. 2, a detailed description will be given of the projection optical system 100 as one of characteristics of the present invention. A description will be given of the Brewster angle. When the light travels from a medium α having a refractive index n_{α} to a medium β having a refractive index n_{β}, the Brewster angle is given by the following Equation 1:
θ_{bs}=arc tan(n_{β}/n_{α}) [EQUATION 1]

From Equation 1, the Brewster θ_{bs} (for the dry system) is 57° where the medium α is the air (gas) having the refractive index n_{α} of 1.0 and the medium β is the final layer of the antireflection coating (which is the uppermost layer that contacts the air) having the refractive index n_{β} of 1.56. Since the refractive index of the final layer in the antireflection coating exhibits a similar value for the KrF layer, ArF laser, and F₂ laser, although the value slightly differs according to wavelengths and materials, the Brewster angle becomes approximately equal to the maximum light angle of 58° for the NA of 0.85.

The instant embodiment is characterized in that the dry, high-NA projection optical system 100 having a NA of 0.85 or greater maintains the light incident angle upon and light exit angle from its optical element (which is a lens in this embodiment) smaller than the Brewster angle determined by the relative refractive index between the air and the final layer (at the gas side) of the antireflection layer formed on the surface of the optical lens.

A description will now be given of the lens 110 in the projection optical system 100. FIG. 2 is a partially enlarged view of the projection optical system 100 shown in FIG. 1 at the side of the object 40. In FIG. 2, the lens 110 is the final lens in the projection optical system 100 (which is located closest to the object 40), and an alternate long and short dash line shows a normal (or a common axis) NM to an exit surface r1 and an incident surface r2 of the lens 110 and the object 40. The projection optical system 100 is a dry system that fills, with the gas, a space between the lens 110 and the object 40 and spaces among optical elements in the projection optical system 100. On the other hand, as described later, a system that uses the fluid instead of the gas is referred to as a wet system.

Arrows in FIG. 2 indicate a ray IL of the maximum NA that passes the outermost part in the pupil in the projection optical system. The ray IL is incident upon the object 40 and the incident angle r2 of the lens 110 at incident angles “a” and “c”. The ray of the maximum NA exits from the exit surface r1 of the lens 110 at an exit angle “b”.

In FIG. 2, the dry projection optical system 100 of the present invention includes at least one meniscus lens that meets the following Equation 2:
a>58°(NA=0.85) [EQUATION 2]
c<b≦Brewster angle determined by the final layer (at the gas side) in the antireflection coating on the incident surface r2
c≦Brewster angle determined by the final layer (at the gas side) in the antireflection coating on the incident surface r1

A description will be given of the curvature of the lens 110 as the meniscus lens. In FIG. 2, the lens 110 satisfies the following Equation 3, where n is the refractive index of the gas, n′ is the refractive index of the lens 110, l is a distance between an incident point IP of the object 40 and the exit surface of the lens 110, l1 is a length of the exit surface r1, and l2 is a length of an incident surface r2:
l1≈l·(n′/n) l2<l1 [EQUATION 3]

When the projection optical system 100 includes plural lenses, it is preferable to satisfy the following Equation 4, where l1, l2, l3, l4, . . . , are lengths of the curved surfaces (or exit and incident surfaces) from the object 40 side:
l3<l2l4<l3 [EQUATION 4]

However, this embodiment allows a curved surface in which l3 is approximately equal to l2, etc. for the balanced aberration of the entire projection optical system.

A description will be given of a difference between the lens 110 as the meniscus lens and the aplanatic lens used, for example, for a microscope's objective lens. The aplanatic satisfies the following Equation 5 in FIG. 2:
l1=1·(n′/n) l2=1·(n/n′) [EQUATION 5]

The aplanatic lens gradually reduces a divergent angle of the light emitted from an incident point IP on the object 40 without generating a spherical aberration so that there is no aberration on the optical axis. The microscope's objective lens is known as a Luboshetz's lens, which arranges multiple aplanatic lenses and reduces the divergent angles sequentially.

On the other hand, the lens 110 does not necessarily have to satisfy the condition of the aplanatic lens, since the lens 110 has such a curvature that the incident and exit angles of each lens are maintained smaller than the Brewster angle determined by the final layer (at the gas side) in the antireflection coatings formed on the incident and exit surfaces.

The projection optical system 100A has a superior optical performance although its NA is so high as 0.85 or greater, providing an exposure apparatus having good critical dimension (“CD”) uniformity and pattern symmetry. The projection optical system 100A can manufacture, at a high yield, semiconductor devices having a pattern of a CD limit in the photolithography.

While it is known that a material of the resist sublimates when the resist-applied object 40 is exposed, it is substantially difficult to assign the final lens of the projection optical system 100 as a replacement part due to its high adjustment sensitivity. Accordingly, a plane-parallel plate is preferably provided between (the final lens of) the projection optical system 100 and the object 40 so that plane-parallel plate can be replaced when the sublimate contamination occurs. This plane-parallel plate can be used to prevent the contamination of the final lens by inorganic and organic matters that mix in small quantities in the atmosphere gas in the dry exposure apparatus, and to prevent the contamination of the final lens by inorganic and organic matters that mix in small quantities in the immersion fluid in the wet system.

The conventional projection exposure apparatus two glass sheets that corrects the aberration of the projection optical system, between the projection optical system and the object, and these two glass sheets are replaced when the sublimate contamination occurs. The total thickness of the two glass sheets corrects the aspheric aberration, inclinations of these sheets correct the on-axis astigmatism, and two glass sheets are angled in a wedge shape correct the on-axis coma.

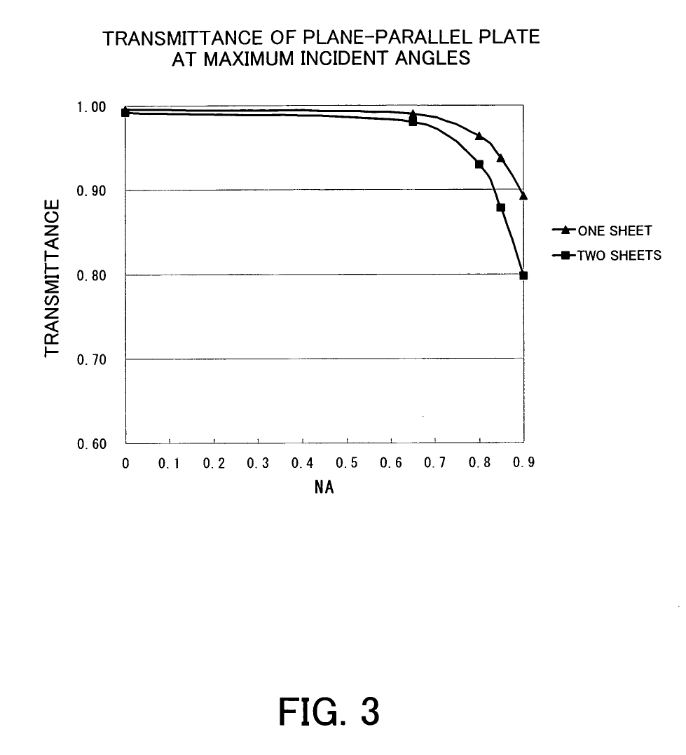

However, if the projection optical system having the NA of 0.85 or greater arranges the plane-parallel plate at the object side, as shown in FIG. 3, the transmittance of the ray having a high NA that exceeds the Brewster angle (which is 58° and NA=0.85 in FIG. 3) determined by the final layer (at the air side) in the antireflection coating abruptly lowers. Here, FIG. 3 is a graph showing a transmittance of a plane-parallel plate relative to a maximum incident angle, where the abscissa axis denotes the maximum incident angle and the ordinate axis denotes the transmittance.

Referring to FIG. 3, at the NA of 0.9, the transmittance of one plane-parallel plate is 89% while the transmittance reduces to 79% for the two plane-parallel plates. Therefore, in the projection optical system having the NA of 0.85 or greater, the number of plane-parallel plates at the object side should be minimized.

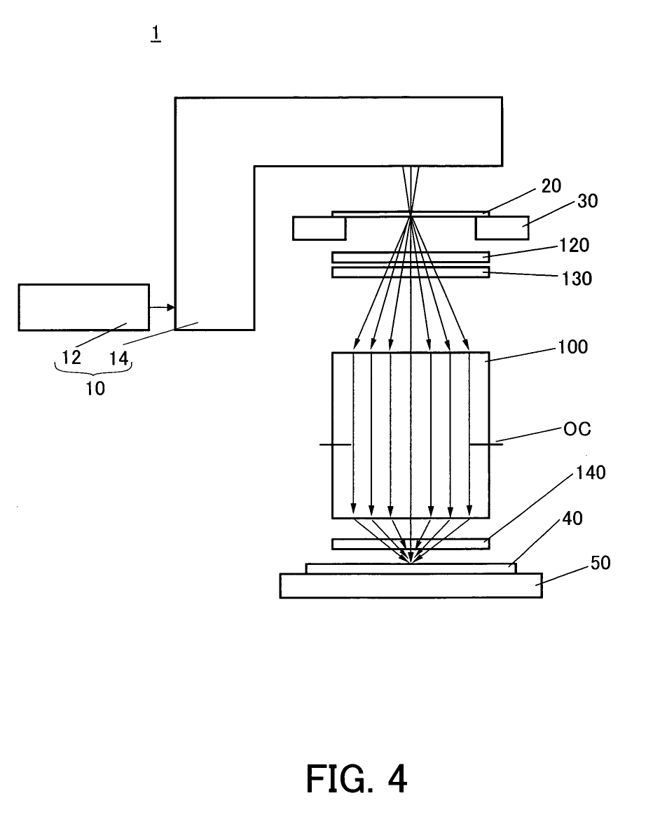

Accordingly, as shown in FIG. 4, two glass sheets 120 and 130 that correct the aberration of the projection optical system 100 are arranged just below the reticle 20 at a position optically conjugate with a position just above the object 40, and a glass sheet 140 that is to be replaced at the time of sublimate contaminations is arranged just above the object 40. Here, FIG. 4 is a schematic block diagram showing the exposure apparatus 1 that arranges a plane-parallel plate for correcting the aberration of the projection optical system 100 and a plane-parallel plate for preventing the sublimate from contaminating the projection optical system 100.

The adjustment resolution improves when two glass sheets 120 and 130 are arranged just below the reticle 20 rather than when they are arranged just above the object 40, and the aberration of the projection optical system 100 can be corrected precisely.

The image-side telecentric projection optical system 100 can equalize the influence (a reduction of the transmittance) of the glass sheet 140 just above the object relative to the light that images out of the optical axis to the influence relative to the light that images on the optical axis, and advantageously prevents the deterioration.

While the above embodiment addresses to the dry projection optical system 100, the immersion exposure is currently calls attentions. The immersion exposure uses the fluid for the medium of the projection optical system at the object side, and promotes the high NA by exposing the object via the fluid that is supplied to at least part of the space between the object and the projection optical system for projecting the reticle pattern onto the object.

Therefore, when the limit of the incident angle of the light incident upon the object is 70°, it corresponds to NA of 0.94 in the dry projection optical system whereas it corresponds to NA of 1.25 in the wet projection optical system for the immersion exposure. Thus, a high-NA projection optical system can be achieved.

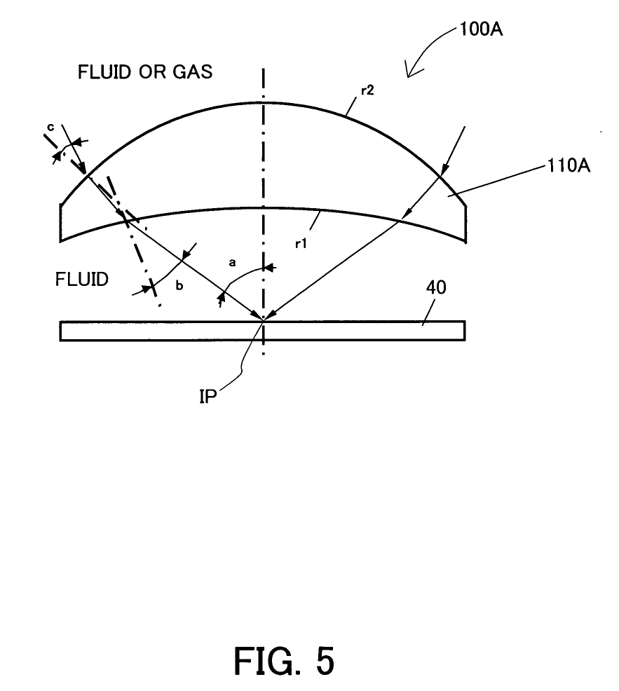

FIG. 5 is a partially enlarged view of the wet projection optical system 100A at the side of the object 40. First, it is necessary to fill, with the pure water (fluid), the medium between the object 40 and the lens 110A as the final lens in the projection optical system 100A (which is the closest to the object 40).

First, the Brewster angle of the wet projection optical system 100A is considered on the assumption that the medium between the object 40 and the lens 110A in the projection optical system 100 is the pure water (fluid) having the refractive index of 1.33. The refractive index of the lens' glass material in the lens 110A is between 1.5 and 1.6, and a refractive-index difference between the pure water and the lens's glass material is small, such as one between about 0.2 and 0.3. The single-layer antireflection coating is enough for each of the exit surface r1 and incident surface r2 of the lens 110A, and preferably has a refractive index between the pure water and the lens's glass material. Such a material includes, for example, MgF₂ having a refractive index of 1.4. In this case, the wet projection optical system 100A has the Brewster angle (for the wet system) of 46.5° smaller than the Brewster angle of 57° of the dry projection optical system 100.

In FIG. 5, the inventive wet projection optical system 100A has at least one meniscus lens that satisfies the following Equation 6:
a>46.5° (NA=0.96 when converted into the dry system) [EQUATION 6]
c<b≦Brewster angle determined by the final layer (at the fluid side) in the antireflection coating on the incident surface r2
c≦Brewster angle determined by the final layer (at the fluid or gas side) in the antireflection coating on the incident surface r1

A description will now be given of the way of determining whether the medium above the lens 110A as the final lens in the projection optical system 100 is to be pure water (fluid) or the air (gas). The following Equation 7 controls the determination where eN is the light incident angle upon the N-th lens (which is “c” in FIG. 5 when the N-th final lens is the lens 110A):
The medium is fluid when θ_{bs} (for the dry system)<θ_{N} The medium is gas when θ_{N}<θ_{bs} (for the dry system) [EQUATION 7]

The instant embodiment is characterized in that the wet, high-NA projection optical system 100A having a NA of 0.96 or greater maintains the light incident angle upon and light exit angle from its optical element smaller than the Brewster angle determined by the relative refractive index between the fluid and the final layer (at the fluid side) of the antireflection layer formed on the exit surface of the optical lens, on a surface that contacts the fluid, and smaller than the Brewster angle determined by the relative refractive index between the gas and the final layer (at the gas side) of the antireflection layer formed on the incident surface of the optical lens, on a surface that contacts the gas.

The projection optical system 100A has a superior optical performance although its NA is so high as 0.96 or greater, providing an exposure apparatus having good CD uniformity and pattern symmetry. The projection optical system 100A can manufacture, at a high yield, semiconductor devices having a pattern of a CD limit in the photolithography.

Turning back to FIG. 1, the object 40 is a wafer in this embodiment, but may be a glass plate and another object to be exposed. The photoresist is applied onto the object 40.

The wafer stage 50 supports the object 40 via a wafer chuck (not shown). Similar to the reticle stage 30, the wafer stage 50 may use a linear motor to move the object 40 in the XYZ-axes directions and the rotational directions around these axes. The positions of the reticle stage 30 and the wafer stage 50 are monitored, for example, by a laser interferometer and the like, so that both are driven at a constant speed ratio. The wafer stage 50 is installed on a stage stool supported on the floor and the like, for example, via a damper. The reticle stage 30 and the projection optical system 100 are installed on a barrel stool (not shown) supported, for example, via a damper to the base frame placed on the floor.

In exposure, light emitted from the light source unit 12, e.g., Koehler-illuminates the reticle 20 via the illumination optical system 14. Light that passes the reticle 20 and reflects the reticle pattern is imaged onto the wafer 40 by the projection optical system 100 or 100A. Since the projection optical system 100A or 100A used for the exposure apparatus 1 can implement superior optical performance although its NA is so high as 0.85 or 0.96 or greater, the exposure apparatus 1 can provide high-quality devices (such as semiconductor devices, LCD devices, photographing devices (such as CCDs, etc.), thin film magnetic heads, and the like).

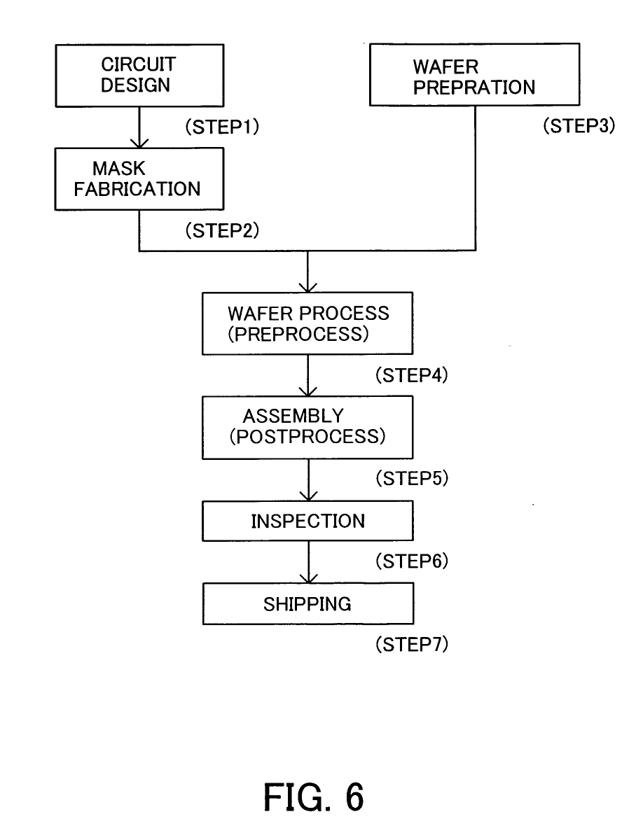

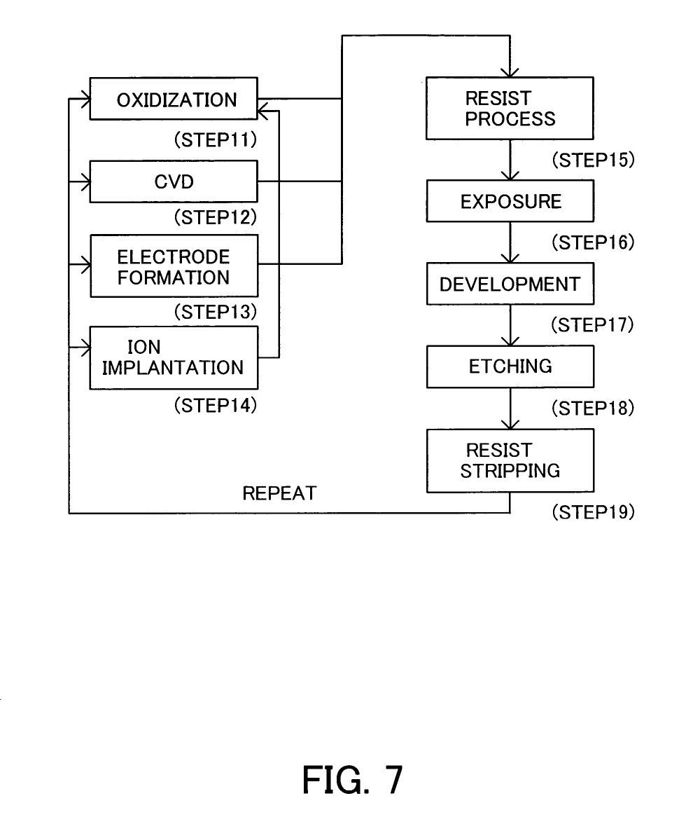

Referring now to FIGS. 6 and 7, a description will be given of an embodiment of a device manufacturing method using the above exposure apparatus 1. FIG. 6 is a flowchart for explaining a manufacture of devices (i.e., semiconductor chips such as IC and LSI, LCDs, CCDs, etc.). A description will now be given of a manufacture of a semiconductor chip, as an example. Step 1 (circuit design) designs a semiconductor device circuit. Step 2 (mask fabrication) forms a mask having a designed circuit pattern. Step 3 (wafer preparation) manufactures a wafer using materials such as silicon. Step 4 (wafer process), which is referred to as a pretreatment, forms actual circuitry on the wafer through photolithography using the mask and wafer. Step 5 (assembly), which is also referred to as a posttreatment, forms into a semiconductor chip the wafer formed in Step 4 and includes an assembly step (e.g., dicing, bonding), a packaging step (chip sealing), and the like. Step 6 (inspection) performs various tests for the semiconductor device made in Step 5, such as a validity test and a durability test. Through these steps, a semiconductor device is finished and shipped (Step 7).

FIG. 7 is a detailed flowchart of the wafer process in Step 4 in FIG. 6. Step 11 (oxidation) oxidizes the wafer's surface. Step 12 (CVD) forms an insulating film on the wafer's surface. Step 13 (electrode formation) forms electrodes on the wafer by vapor disposition and the like. Step 14 (ion implantation) implants ions into the wafer. Step 15 (exposure) applies the photosensitive material described in the above embodiments onto the wafer, and uses the exposure apparatus 1 to expose a circuit pattern on the mask onto the wafer. Step 16 (development) develops the exposed wafer. Step 17 (etching) etches parts other than a developed resist image. Step 18 (resist stripping) removes the disused resist after etching. These steps are repeated, and multilayer circuit patterns are formed on the wafer. This manufacturing method can manufacture higher quality devices than the conventional ones. Thus, the device manufacturing method that uses the exposure apparatus 1 and the device as resultant products constitute one aspect according to the present invention.

The present invention can provide an exposure apparatus that has good optical performance.

Further, the present invention is not limited to these preferred embodiments, but various modifications and variations may be made without departing from the spirit and scope of the present invention. For example, the invention is applicable to the optical element in the illumination optical system having a NA of 0.85 or higher.

This application claims foreign priority benefits based on Japanese Patent Application No. 2004-012805, filed on Jan. 21, 2004, which is hereby incorporated by reference herein in its entirety as if fully set forth herein.

1. An exposure apparatus comprising:
a projection optical system for projecting a pattern of a reticle onto an object, said projection optical system having a numerical aperture of 0.85 or higher,
wherein said projection optical system includes:
an optical element; and
an antireflection coating applied to said optical element, said antireflection coating including plural layers, and
wherein an incident light angle upon the optical element and an exit light angle from the optical element, on a surface of the antireflection coating which contacts gas, do not exceed a Brewster angle determined by a relative refractive index between the gas and a final layer among the plural layers, which is the closest to the gas.

2. An exposure apparatus according to claim 1, further comprising:
a first plane-parallel plate, located between said projection optical system and the object.

3. An exposure apparatus according to claim 2, further comprising:
a second plane-parallel plate, located between the reticle and said projection optical system.

4. An exposure apparatus comprising:
a projection optical system for projecting a pattern of a reticle onto an object; and
a fluid that fills at least part of a space between said projection optical system and the object, said exposure apparatus exposing the object through the fluid,
wherein said projection optical system includes:
an optical element; and
an antireflection coating applied to said optical element,
wherein an incident light angle upon the optical element and an exit light angle from the optical element, on a surface of the antireflection coating which contacts the fluid, do not exceed a Brewster angle determined by a relative refractive index between the fluid and a final layer in the antireflection coating, which is the closest to the fluid.

5. An exposure apparatus according to claim 4, wherein said projection optical system has a numerical aperture of 0.96 or higher.

6. An exposure apparatus according to claim 4, further comprising:
a first plane-parallel plate, located between said projection optical system and the object.

7. An exposure apparatus according to claim 6, further comprising:
a second plane-parallel plate, located between the reticle and said projection optical system.

8. An exposure apparatus comprising:
a projection optical system for projecting a pattern of a reticle onto an object, said projection optical system having a numerical aperture of 0.85 or higher,
wherein said projection optical system includes:
an optical element located closest to the object, said optical element having an incident surface upon which light is incident and an exit surfaces from which the light exits; and
antireflection coatings applied to the incident and exit surfaces of said optical element, each antireflection coating including plural layers, and
wherein the following equations are met where a is an incident angle of the light upon the object, b is an exit angle of the light from the exit surface, and c is an incident angle of the light upon the incident surface:
c<b≦a Brewster angle determined by a final surface of the antireflection coating on the incident surface, which is the farthest away from the optical element; and
c<a Brewster angle determined by a final surface of the antireflection coating on the exit surface, which is the farthest away from the optical element.

9. An exposure apparatus according to claim 8, further comprising:
a first plane-parallel plate, located between said projection optical system and the object.

10. An exposure apparatus according to claim 9, further comprising:
a second plane-parallel plate, located between the reticle and said projection optical system.

11. An exposure apparatus comprising:
a projection optical system for projecting a pattern of a reticle onto an object; and
a fluid that fills at least part of a space between said projection optical system and the object, said exposure apparatus exposing the object through the fluid,
wherein said projection optical system includes:
an optical element located closest to the object, said optical element having an incident surface upon which light is incident and an exit surfaces from which the light exits; and
antireflection coatings applied to the incident and exit surfaces of said optical element, and
wherein the following equations are met where a is an incident angle of the light upon the object, b is an exit angle of the light from the exit surface, and c is an incident angle of the light upon the incident surface:
c<b≦a Brewster angle determined by the antireflection coating on the incident surface; and
c<a Brewster angle determined by the antireflection coating on the exit surface.

12. An exposure apparatus according to claim 11, wherein said projection optical system has a numerical aperture of 0.96 or higher.

13. An exposure apparatus according to claim 12, further comprising:
a first plane-parallel plate, located between said projection optical system and the object.

14. An exposure apparatus according to claim 13, further comprising:
a second plane-parallel plate, located between the reticle and said projection optical system.

15. A device manufacturing method comprising the steps of:
exposing an object using an exposure apparatus according to claim 1; and
developing the object that has been exposed.

16. A device manufacturing method comprising the steps of:
exposing an object using an exposure apparatus according to claim 4; and
developing the object that has been exposed.

17. A device manufacturing method comprising the steps of:
exposing an object using an exposure apparatus according to claim 8; and
developing the object that has been exposed.

18. A device manufacturing method comprising the steps of:
exposing an object using an exposure apparatus according to claim 11; and
developing the object that has been exposed.
